(19) United States
(12) Patent Application Publication
(10) Pub. No.: US 2026/0312509 A1
(43) Pub. Date: Oct. 8, 2026

(54) POWER CONVERSION DEVICE

(71) Applicant: Hitachi, Ltd., Tokyo (JP)

(72) Inventors: Masahiro SEO, Tokyo (JP); Takeshi TOKUYAMA, Tokyo (JP)

(73) Assignee: Hitachi, Ltd., Tokyo (JP)

(21) Appl. No.: 19/123,258

(22) PCT Filed: Aug. 25, 2023
(86) PCT No.: PCT/JP2023/030734

§ 371 Date: Apr. 22, 2025

(30) Foreign Application Priority Data
Oct. 25, 2022 (JP) 2022-170919

(51) Int. Cl. H02M 7/00

(52) U.S. Cl. CPC H02M 7/003

(57) ABSTRACT

A power conversion device includes: an upper arm semiconductor element connected to a positive electrode wiring line; a lower arm semiconductor element connected to a negative electrode wiring line; a first AC wiring line connecting the upper and lower arm semiconductor elements; and a second AC wiring line connecting the upper and lower arm semiconductor elements. The first AC wiring line is positioned whereby the first AC wiring line is opposite to the positive electrode wiring line and the negative electrode wiring line across the upper arm semiconductor element and the lower arm semiconductor element. The second AC wiring line is formed positioned whereby the second AC wiring line is opposite to the first AC wiring line across the upper arm semiconductor element and the lower arm semiconductor element, and is stacked together with the positive electrode wiring line and the negative electrode wiring line.

### TECHNICAL FIELD

The present invention relates to a power conversion device.

### BACKGROUND ART

A semiconductor device using a silicon carbide (SiC) chip is required to have a configuration in which, by utilizing its features of high-speed switching and a small chip size, a number of chips mounted in parallel are driven. This configuration is considered to be necessary from the viewpoint of improving the yield of a power module included in a power conversion device and facilitating adjustment of a source inductance. However, to connect one-chip power modules in parallel, low inductance must be achieved.

For example, PTL 1 described below discloses a circuit board in which a lead frame has AC output terminals on its both sides to create a bypass for a steep current and, in such a configuration, currents flowing through upper and lower wiring patterns of a board act against each other and cancel the magnetic flux.

### CITATION LIST

### Patent Literature

PTL 1: JP 2014-183703 A

### SUMMARY OF INVENTION

### Technical Problem

In a conventional structure, when SiC chips are connected in parallel to increase a capacitance, AC wiring lines and signal wiring lines intersect and are magnetically coupled with each other. As a result,, a steep transient current flowing to an AC output side at the time of switching creates a strong magnetic field and this magnetic field generates magnetic coupling noise to a signal circuit, which is a problem. The present invention has been conceived in view of this problem, and an object of the present invention is to provide a power conversion device that achieves low inductance and low noise simultaneously.

### Solution to Problem

A power conversion device includes: an upper arm semiconductor element connected to a positive electrode wiring line; a lower arm semiconductor element connected to a negative electrode wiring line; a first AC wiring line connecting the upper arm semiconductor element to the lower arm semiconductor element; and a second AC wiring line connecting the upper arm semiconductor element to the lower arm semiconductor element. The first AC wiring line is formed at a position at which the first AC wiring line is opposite to the positive electrode wiring line and the negative electrode wiring line across the upper arm semiconductor element and the lower arm semiconductor element. The second AC wiring line is formed at a position at which the second AC wiring line is opposite to the first AC wiring line across the upper arm semiconductor element and the lower arm semiconductor element, and is stacked together with the positive electrode wiring line and the negative electrode wiring line.

### Advantageous Effects of Invention

A power conversion device that achieves low inductance and low noise simultaneously can be provided.

### BRIEF DESCRIPTION OF DRAWINGS

FIGS. 1A-1B is an explanatory diagram of a semiconductor device making up a power conversion device according to one embodiment of the present invention.

FIGS. 2A-2B is an explanatory diagram of a second current path passing through a second AC wiring line according to the one embodiment of the present invention.

FIGS. 3A-3B shows the semiconductor device in its molded form and an exploded view of the semiconductor device.

FIGS. 4A-4B depicts a modification of the semiconductor device of FIGS. 1A-1B.

FIG. 5 is an explanatory diagram of a first layer of a three-phase inverter according to the one embodiment of the present invention.

FIG. 6 is an explanatory diagram of a second layer of the three-phase inverter of FIG. 5.

Embodiments of the present invention will hereinafter be described with reference to the drawings. The following description and drawings are exemplary one for explanation of the present invention, and, to make the explanation clear, will be omitted or simplified when necessary. The present invention can be implemented in various forms different from embodiments described herein. Unless otherwise specified, each constituent element of a single form and of a plural form are both applicable.

Positions, sizes, shapes, ranges, and the like of constituent elements shown in the drawings may not represent actual positions, sizes, shapes, ranges, and the like. This is to facilitate understanding of the invention. The present invention, therefore, is not necessarily limited by positions, sizes, shapes, ranges, and the like indicated in the drawings.

### OVERALL CONFIGURATION OF ONE EMBODIMENT AND DEVICE OF PRESENT INVENTION

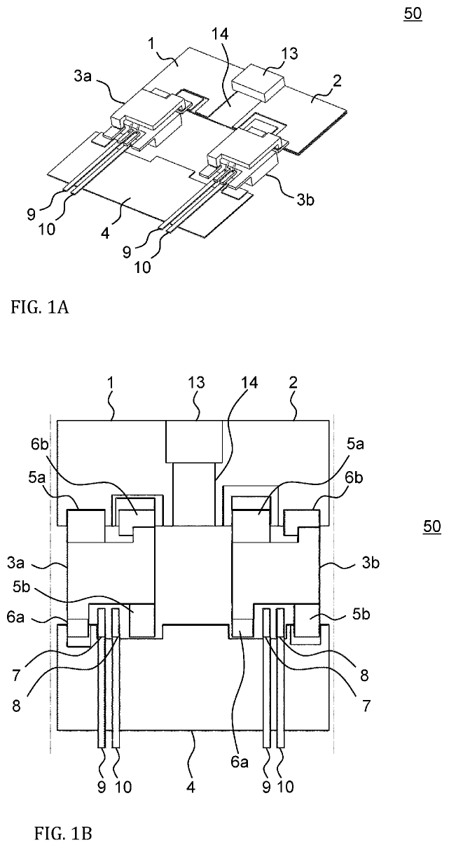

### FIGS. 1A-1B

FIG. 1A is a perspective view of a semiconductor device 50, and FIG. 1B is a top view of the semiconductor device 50 of FIG. 1A. It should be noted that in FIGS. 1A and 1B, only main components of the semiconductor device 50 are shown and a mold, an insulating layer of a substrate, and the like of the semiconductor device 50 are omitted.

The semiconductor device 50 includes a positive electrode wiring line 1, a negative electrode wiring line 2, an upper arm semiconductor device 3a, a lower arm semiconductor device 3b, an AC output wiring line 4 (first AC wiring line 4), and a second AC wiring line 14. The upper arm semiconductor device 3a and the lower arm semiconductor device 3b each have a gate signal terminal 7 and a source signal terminal 8. The gate signal terminal 7 is connected to a gate signal wiring line 9, and the source signal terminal 8 is connected to a source signal wiring line 10. The signal wiring lines 9 and 10 connected to the upper arm semiconductor element or the lower arm semiconductor element via the terminals 7 and 8 are arranged on a side where the AC output wiring line 4 is formed. The upper arm semiconductor device 3a and the lower arm semiconductor device 3b each have drain terminals 5a and 5b and source terminals 6a and 6b.

The upper arm semiconductor device 3a and the lower arm semiconductor device 3b each include a semiconductor element, such as a SiC chip. Hereinafter, a semiconductor element included in the upper arm semiconductor device 3a is referred to as an upper arm semiconductor element, and a semiconductor element included in the lower arm semiconductor device 3b is referred to as a lower arm semiconductor element. The upper arm semiconductor element is connected to the positive electrode wiring line 1. The lower arm semiconductor element is connected to the negative electrode wiring line 2.

A capacitor 13 is, for example, a ceramic capacitor, and is connected to the AC output wiring line 4 via the upper arm semiconductor element and the lower arm semiconductor element. The capacitor 13 is connected to the positive electrode wiring line 1 and to the negative electrode wiring line 2. The second AC wiring line 14 is formed in a layer below a wiring layer where the positive electrode wiring line 1 and the negative electrode wiring line 2 are formed, and is disposed in such a way as to be stacked together with the positive electrode wiring line 1 and the negative electrode wiring line 2. In FIGS. 1A-1B, the second AC wiring line 14 is structured such that only the part of second AC wiring line 14 that is at the position of the capacitor 13 is exposed between the positive electrode wiring line 1 and the negative electrode wiring line 2.

The AC output wiring line 4 is an output phase connected to wiring lines of a three-phase motor (not illustrated). The AC output wiring line 4 and the second AC wiring line 14 are each connected to the upper arm semiconductor element and to the lower arm semiconductor element. The AC output wiring line 4 is formed at a position at which the AC output wiring line 4 is opposite to the positive electrode wiring line 1 and the negative electrode wiring line 2 across the upper arm semiconductor element and the lower arm semiconductor element. The second AC wiring line 14 is formed at a position at which the second AC wiring line 14 is opposite to the AC output wiring line 4 across the upper arm semiconductor element and the lower arm semiconductor element.

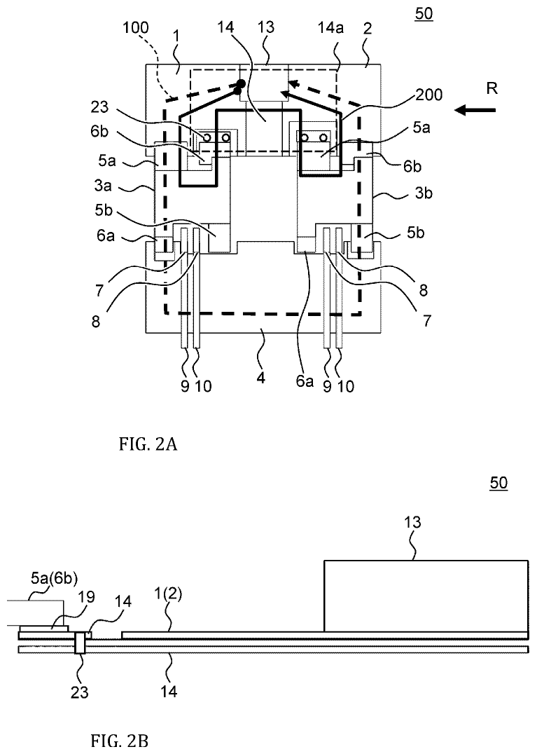

### FIGS. 2A-2B

FIG. 2A is a diagram for explaining a second current path 200 through which a current flows in the semiconductor device 50 according to the present invention, and FIG. 2B is a cross-sectional view of the semiconductor device 50 of FIG. 2A seen in a direction indicated by an arrow R. In a conventional case, the AC output wiring line 4 is connected to an AC output wiring line of a wiring layer in a lower layer of a substrate (not shown) through a via 23, and is connected also to the upper arm semiconductor device 3a and the lower arm semiconductor device 3b. This configuration, however, involves a risk that at switching by the upper arm semiconductor device 3a or the lower arm semiconductor device 3b, a steep current flows through a path 100 via the AC output wiring line 4. The steep current flowing through the path 100 generates magnetic noise at the gate signal wiring line 9 and the source signal wiring line 10 that are laid on the AC output wiring line 4. This problem gives rise to a possibility that the reliability of operation of the semiconductor device 50 may drop.

To deal with this, according to the present invention, each of the upper arm semiconductor device 3a and the lower arm semiconductor device 3b has a pair of a drain terminal 5a and a source terminal 6b and a pair of a drain terminal 5b and a source terminal 6a on its both ends, respectively. In addition, the second AC wiring line 14 is located below the positive electrode wiring line 1, the negative electrode wiring line 2, and the capacitor 13, and is connected to the upper arm semiconductor device 3a and the lower arm semiconductor device 3b via the via 23 and the drain terminal 5a and the source terminal 6b in an upper layer. The terminals 5a and 6b and the wiring line 14 connected to the via 23 are jointed by solder 19.

In this manner, the second AC wiring line 14 is made into a laminate structure with respect to the positive electrode wiring line 1 and the negative electrode wiring line 2. In this configuration, the second current path 200 is formed at the time of switching, which current path 200 allows currents to flow in directions opposite to each other. Specifically, magnetic flux created by a steep current generated at the positive electrode wiring line 1 and the negative electrode wiring line 2 is canceled by magnetic flux created by a steep current generated at the second AC wiring line 14. This reduces the inductances of the positive electrode wiring line 1 and the negative electrode wiring line 2.

In addition, as a steep current on the AC side flows through the second AC wiring line 14, a counter current to the steep current flows through the upper arm semiconductor device 3a and the lower arm semiconductor device 3b as well. Thus, as a result of canceling of magnetic flux at the positive electrode wiring line 1 and the negative electrode wiring line 2, the inductance of the second AC wiring line 14 is reduced as well. Furthermore, such a flow of a steep current through the second AC wiring line 14 with a low inductance leads to a decrease in a steep current (current flowing through the first current path 100) flowing through the AC output wiring line 4 on a side where the signal wiring lines 9 and 10 are located, which reduces magnetic noise applied to the signal wiring lines 9 and 10. In this manner, low inductance and low noise can be achieved simultaneously.

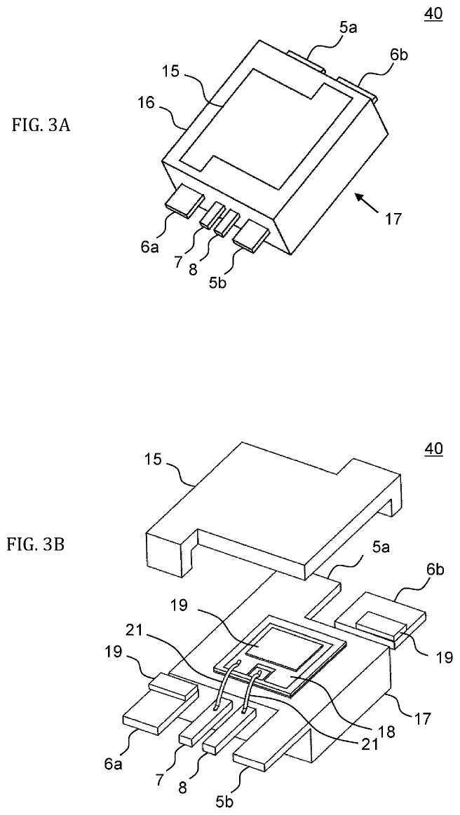

### FIGS. 3A-3B

FIG. 3A is an overall perspective view of the semiconductor device 50 sealed with a molding resin, and FIG. 3B is an exploded view of the semiconductor device 50. On the semiconductor device 50 mold-sealed with a resin 16, a part of a source conductor 15 is exposed. On a surface (back surface) opposite to a surface on which a part of the source conductor 15 is exposed, a part of a drain conductor 17 is exposed in the same manner, which is not illustrated. The source terminal 6a, the gate signal terminal 7, the source signal terminal 8, the drain terminal 5b, the drain terminal 5a, and the source terminal 6b project out of a mold part.

The source terminal 6a and the source terminal 6b are electrically connected to the source conductor 15 via the solder 19. The gate signal terminal 7 and the source signal terminal 8 are electrically connected to each other via a SiC chip 18 and wires 21. The SiC chip 18 is disposed between the source conductor 15 and the drain conductor 17, and is electrically connected to each conductor through the solder 19.

The source conductor 15 and the drain conductor 17 exposed on the surface of a circuit body 40 mold-sealed with the resin 16 are each overlaid with an insulating layer, and a cooling water channel (not illustrated) is superposed on the insulating layer to be in contact therewith. This cooling water path releases heat from the SiC chip 18 of the circuit body 40. On the upper arm semiconductor element side, the source terminal 6b is connected to the second AC wiring line 14 through the via 23. On the lower arm semiconductor element side, the drain terminal 5a is connected to the second AC wiring line 14 through the via 23 (see FIGS. 2A-2B). By doing this, a circuit that bypaths a steep current flow, using the second AC wiring line 14, can be formed.

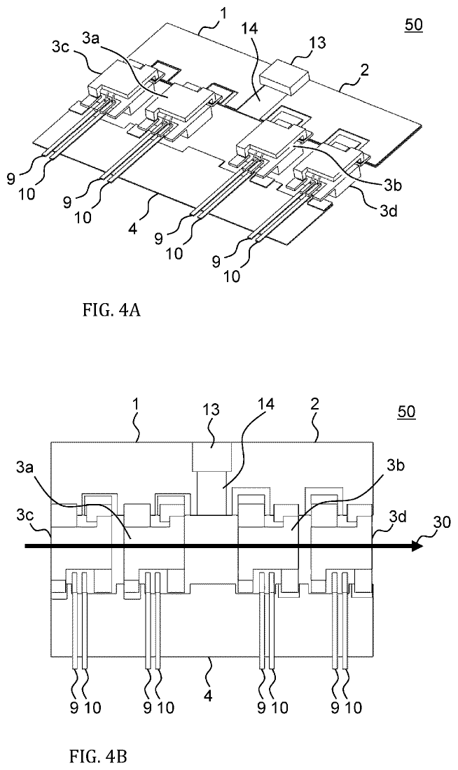

As described above, the circuit body 40 as a circuit body having the upper arm semiconductor element (upper arm circuit body) includes the conductors 15 and 17 connected to the upper arm semiconductor element, and the circuit body 40 as a circuit body having the lower arm semiconductor element (lower arm circuit body) includes the conductors 15 and 17 connected to the lower arm semiconductor element. The upper arm circuit body and the lower arm circuit body are thus identical in structure. This allows use of common components, thus allowing cost reduction. In addition, circuit bodies 40 of the same structure offer an advantage in a case where the circuit bodies 40 connected in parallel are lined up, as shown in FIGS. 4A-4B to be referred to later. In such a case, the number of circuit bodies 40 to be arranged can be easily changed according to their output capacities.

### MODIFICATIONS

### FIGS. 4A-4B

FIG. 4A is an explanatory diagram of the semiconductor device 50 composed of a plurality of circuit bodies 40 connected in parallel, and FIG. 4B is a top point view of the semiconductor device 50 of FIG. 4A. A plurality of upper arm semiconductor elements and a plurality of lower arm semiconductor elements may be connected in parallel. Even in a such case where the semiconductor elements are connected in parallel, a steep current flows through the second AC wiring line 14, because of which noise of signal wiring lines can be reduced. In addition, even in the case where the semiconductor elements are connected in parallel, the signal wiring lines 9 and 10 can be extended in the same direction to compactify and miniaturize the signal circuit as noise is reduced.

Upper arm semiconductor devices 3a and 3c each having the upper arm semiconductor element and lower arm semiconductor devices 3b and 3d each having the lower arm semiconductor element are lined up in a row. Along this row, cooling water channels (not illustrated), in which cooling water flows, are laid on both surfaces of the semiconductor device 50, respectively. FIG. 4B shows a cooling water channel 30 of a cooling water channel laid on this side with respect to the paper surface.

The cooling water channels laid on both surfaces of the semiconductor device 50 come into contact with the upper arm semiconductor devices 3a and 3c and the lower arm semiconductor devices 3b and 3d, respectively, thus cooling the semiconductor devices 3a to 3d. In this manner, lining up the semiconductor devices 3a to 3d in a row reduces the width of a cooling range. As a result, maintenance of the cooling performance of the semiconductor device 50 and miniaturization of the semiconductor device 50 can be simultaneously achieved as the current capacity of the semiconductor devices 3a to 3d are increased.

The cooling water channels may be laid such that cooling water flowing along one surface and cooling water flowing along the other surface opposite to the one surface are opposite in direction to each other. This allows well-balanced cooling of the semiconductor device 50.

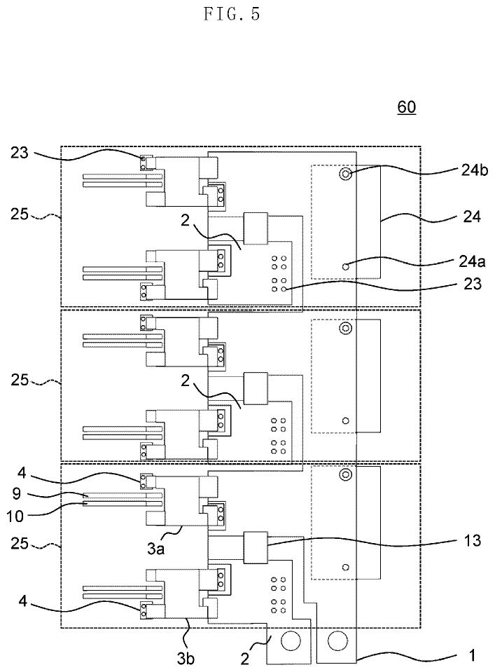

### FIG. 5

Wiring of a first layer of the substrate in a three-phase inverter 60 will be described, the three-phase inverter 60 being composed of a combination of semiconductor devices 50 of three phases each having the upper and lower arm semiconductor elements. An inverter 25 of one phase (one-phase inverter 25) includes the capacitor 13 that absorbs a steep current, a smoothing capacitor 24 that absorbs a current ripple caused by carriers, and the upper arm semiconductor device 3a and the lower arm semiconductor device 3b. Three one-phase inverters 25 are lined up to form the three-phase inverter 60.

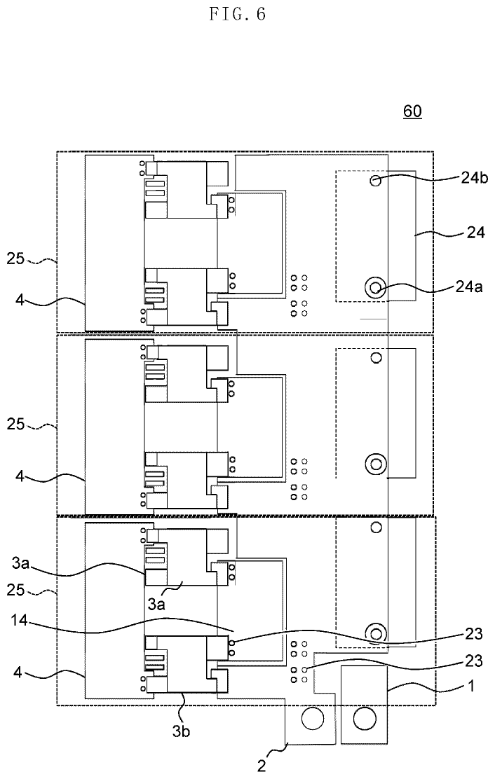

In the three-phase inverter 60, AC output wiring lines 4 are each connected to an AC output wiring line 4 in a second layer (see FIG. 6 to be referred to later) via the via 23, and three separate negative electrode wiring lines 2 are also each connected to a negative electrode wiring line 2 in the second layer via the via 23. The positive electrode wiring line 1 is connected to a terminal 24a, which is one of two terminals the smoothing capacitor 24 has.

### FIG. 6

FIG. 6 shows the second layer of the three-phase inverter 60 shown in FIG. 5. It should be noted that the upper arm semiconductor device 3a, the lower arm semiconductor device 3b, and the smoothing capacitor 24 in the second layer are at the same positions as those in the first layer. Each of the negative electrode wiring line 2, the AC output wiring line 4, and the second AC wiring line 14 in the second layer is connected to the first layer (FIG. 5) through the via 23. Through AC output wiring lines 4 of three phases, a three-phase alternating current can be output. The smoothing capacitor 24 is connected to the first layer via a terminal 24b not connected to the positive electrode wiring line 1, the terminal 24b being one of two terminals 24a and 24b the smoothing capacitor 24 has.

In this manner, each one-phase inverter of the three-phase inverter 60 includes the second AC wiring line 14. In this configuration, magnetic noise to the signal wiring lines caused by a steep current generated at the time of each SiC chip's switching can be suppressed. In addition, as described above, extending the signal wiring lines 9 and 10 in one direction compactifies the whole signal circuit packaging, thus miniaturizing the signal circuit and the three-phase inverter 60 as a whole. Furthermore, as described above, the cooling water channel (not illustrated) is formed on the upper surface of the semiconductor device 50 in the direction in which the semiconductor devices 50 are lined up, and cooling water is caused to flow in the direction of going from the top to the bottom of the paper surface shown in FIGS. 5 and 6. The cooling water channel is formed also on the back surface of the semiconductor device 50 in the same manner, and cooling water is caused to flow in the direction of going from the bottom to the top of the paper surface. By this process, the semiconductor devices 50 can be cooled efficiently in a narrow range.

The above-described one embodiment of the present invention offers the following effects.
(1) A power conversion device 60 includes: the upper arm semiconductor element connected to the positive electrode wiring line 1; the lower arm semiconductor element connected to the negative electrode wiring line 2; the first AC wiring line 4 connecting the upper arm semiconductor element to the lower arm semiconductor element; and the second AC wiring line 14 connecting the upper arm semiconductor element to the lower arm semiconductor element. The first AC wiring line 4 is formed at the position at which the first AC wiring line 4 is opposite to the positive electrode wiring line 1 and the negative electrode wiring line 2 across the upper arm semiconductor element and the lower arm semiconductor element. The second AC wiring line 14 is formed at the position at which the second AC wiring line 14 is opposite to the first AC wiring line 4 across the upper arm semiconductor element and the lower arm semiconductor element, and is stacked together with the positive electrode wiring line 1 and the negative electrode wiring line 2. By adopting this configuration, the power conversion device 60 that achieves low inductance and low noise simultaneously can be provided.
(2) The signal wiring lines 9 and 10 connected to the upper arm semiconductor element or the lower arm semiconductor element are arranged on the side where the first AC wiring line 4 is formed, relative to the upper arm semiconductor element and the lower arm semiconductor element, and a plurality of the upper arm semiconductor elements and a plurality of the lower arm semiconductor elements are connected in parallel. With this configuration, low nose can be achieved.
(3) The upper arm semiconductor elements and the lower arm semiconductor elements are lined up in a row. With this configuration, the power conversion device 60 can be miniaturized when its both surfaces are cooled by the cooling water channels.
(4) The power conversion device 60 includes: the upper arm circuit body including the upper arm semiconductor element and the conductors 15 and 17 connected to the upper arm semiconductor element; and the lower arm circuit body including the lower arm semiconductor element and the conductors connected to the lower arm semiconductor element. The upper arm circuit body and the lower arm circuit body are identical in structure. This configuration allows cost reduction.

It should be noted that the present invention is not limited to the above embodiment and that a combination of various modifications and other configurations may be implemented on condition that such a combination does not depart from the substance of the present invention. In addition, the present invention is not limited to an embodiment including all constituent elements described above, and includes an embodiment from which some constituent elements are deleted.

### REFERENCE SIGNS LIST

1 positive electrode wiring line
2 negative electrode wiring line
3a, 3c upper arm semiconductor device
3b, 3d lower arm semiconductor device
4 AC output wiring line
5a, 5b drain terminal
6a, 6b source terminal
7 gate signal terminal
8 source signal terminal
9 gate signal wiring line
10 source signal wiring line
13 capacitor
14 second AC wiring line
14a stack range
15 source conductor
16 resin
17 drain conductor
18 Sic chip
19 solder
21 wire
23 via
24 smoothing capacitor
24a first terminal
24b second terminal
25 inverter (one phase)
30 cooling water path
40 circuit body
50 semiconductor device
60 three-phase inverter
100 first current path
200 second current path

1. A power conversion device comprising:
an upper arm semiconductor element connected to a positive electrode wiring line;
a lower arm semiconductor element connected to a negative electrode wiring line;
a first AC wiring line connecting the upper arm semiconductor element to the lower arm semiconductor element; and
a second AC wiring line connecting the upper arm semiconductor element to the lower arm semiconductor element,
wherein the first AC wiring line is formed at a position at which the first AC wiring line is opposite to the positive electrode wiring line and the negative electrode wiring line across the upper arm semiconductor element and the lower arm semiconductor element, and
the second AC wiring line is formed at a position at which the second AC wiring line is opposite to the first AC wiring line across the upper arm semiconductor element and the lower arm semiconductor element, and is stacked together with the positive electrode wiring line and the negative electrode wiring line.

2. The power conversion device according to claim 1, wherein
signal wiring lines connected to the upper arm semiconductor element or the lower arm semiconductor element are arranged on a side where the first AC wiring line is formed, relative to the upper arm semiconductor element and the lower arm semiconductor element, and
a plurality of the upper arm semiconductor elements and a plurality of the lower arm semiconductor elements are connected in parallel.

3. The power conversion device according to claim 1, wherein the upper arm semiconductor element and the lower arm semiconductor element are lined up in a row.

4. The power conversion device according to claim 1, comprising:
an upper arm circuit body including the upper arm semiconductor element and a conductor connected to the upper arm semiconductor element; and
a lower arm circuit body including the lower arm semiconductor element and a conductor connected to the lower arm semiconductor element,
wherein the upper arm circuit body and the lower arm circuit body are identical in structure.
